(19) United States
(12) Patent Application Publication
(10) Pub. No.: US 2022/0146672 A1
(43) Pub. Date: May 12, 2022

(54) LASER RADAR

(71) Applicant: Panasonic Intellectual Property Management Co., Ltd., Osaka (JP)

(72) Inventors: Tetsuhisa Hosokawa, Osaka (JP); Yasuyuki Kano, Osaka (JP)

(21) Appl. No.: 17/584,235

(22) Filed: Jan. 25, 2022

Related U.S. Application Data
(63) Continuation of application No. PCT/JP2020/021729, filed on Jun. 2, 2020.

(30) Foreign Application Priority Data
Jul. 26, 2019 (JP) 2019-137672
Aug. 26, 2019 (JP) 2019-154081

(51) Int. Cl. G01S 17/08; G01S 7/481

(52) U.S. Cl. CPC G01S 17/08; G01S 7/4813

(57) ABSTRACT

A laser radar includes: a projection optical system configured to project laser light emitted from a laser light source, to a target region; and a light-receiving optical system configured to condense reflected light that is the laser light reflected by an object existing in the target region, onto a photodetector. The projection optical system and the light-receiving optical system are disposed such that optical axes thereof are separated from each other. The photodetector includes a plurality of sensor portions aligned in a direction perpendicular to a separation direction of these optical axes. The plurality of sensor portions each have a shape that is long in the separation direction of the optical axes.

### CROSS REFERENCE TO RELATED APPLICATION

This application is a continuation of International Application No. PCT/JP2020/021729 filed on Jun. 2, 2020, entitled “LASER RADAR”, which claims priority under 35 U.S.C. Section 119 of Japanese Patent Application No. 2019-137672 filed on Jul. 26, 2019, entitled “LASER RADAR” and Japanese Patent Application No. 2019-154081 filed on Aug. 26, 2019, entitled “LASER RADAR”. The disclosure of the above applications is incorporated herein by reference.

### BACKGROUND OF THE INVENTION

### 1. Field of the Invention

The present invention relates to a laser radar for detecting an object by using laser light.

### 2. Disclosure of Related Art

In recent years, a laser radar has been used for the security purpose of detecting intrusion into a building, etc. Generally, the laser radar irradiates a target region with laser light and detects the presence/absence of an object in the target region on the basis of reflected light of the laser light. In addition, the laser radar measures the distance to the object on the basis of the time taken from the irradiation timing of the laser light to the reception timing of the reflected light.

Japanese Patent No. 6217537 describes an optical distance measurement device that projects laser light from a light projecting part, receives reflected light of the laser light by a light receiving part, and measures the distance to an object. In this device, the light projecting part and the light receiving part are disposed so as to be separated from each other in a direction perpendicular to the projection direction of the laser light. In addition, in order to compensate for the parallax between the light projecting part and the light receiving part, a light receiving element of the light receiving part is set to have a shape that is long in the separation direction of the light projecting part and the light receiving part.

In this configuration, the reflected light of the laser light projected from the light projecting part is received by the single light receiving element. Therefore, in this configuration, the presence/absence of an object and the distance to the object are only detected in the entirety of a target region (projection region of laser light).

However, it is preferable that the laser radar can detect at which position in the target region the object exists. For example, it is preferable that the presence/absence of an object and the distance to the object can be detected in each of a plurality of division regions into which the target region is divided. As a configuration for that purpose, for example, a configuration in which the light receiving surface of a photodetector that receives the reflected light is divided into a plurality of portions in one direction can be used. Accordingly, the presence/absence of an object can be detected in the division region of the target region corresponding to each division region of the light receiving surface. In this configuration, the resolution of object detection in the target region can be increased as the number of divisions of the light receiving surface is increased.

However, if there is a parallax between the light projecting part and the light receiving part, a condensed spot of the reflected light moves on the light receiving surface of the photodetector in accordance with a change in the distance to the object. Therefore, as described above, in the case where the light receiving surface of the photodetector is divided into a plurality of portions, the condensed spot of the reflected light may move in the division direction of the light receiving surface in accordance with a change in the distance to the object, depending on the manner in which the light receiving surface is divided. In this case, it becomes difficult to properly detect an object in each division region on the target region.

### SUMMARY OF THE INVENTION

A laser radar according to a main aspect of the present invention includes: a projection optical system configured to project laser light emitted from a laser light source, to a target region; and a light-receiving optical system configured to condense reflected light that is the laser light reflected by an object existing in the target region, onto a photodetector. The projection optical system and the light-receiving optical system are disposed such that optical axes thereof are separated from each other. The photodetector includes a plurality of sensor portions aligned in a direction perpendicular to a separation direction of the optical axes. The plurality of sensor portions each have a shape that is long in the separation direction of the optical axes.

In the laser radar according to this aspect, since the photodetector includes the plurality of sensor portions, an object can be detected in each division region, corresponding to each sensor portion, on the target region on the basis of the output from each sensor portion. In addition, since the plurality of sensor portions are aligned in the direction perpendicular to the separation direction of the optical axes, a condensed spot of the reflected light moves in the direction perpendicular to the alignment direction of the sensor portions in accordance with a change in the distance to the object. Therefore, even if the distance to the object changes, the object can be properly detected in each division region. Furthermore, since the plurality of sensor portions each have a shape that is long in the separation direction of the optical axes, that is, in the direction perpendicular to the alignment direction of the sensor portions, even if the condensed spot of the reflected light moves in accordance with a change in the distance to the object, the reflected light can be received by each sensor portion. Therefore, even if the distance to the object changes, the object can be more properly detected on the basis of the output from each sensor portion.

### BRIEF DESCRIPTION OF THE DRAWINGS

FIG. 1 is a perspective view for illustrating assembly of a laser radar according to an embodiment;

FIG. 2 is a perspective view showing a configuration of the laser radar in a state where assembly of a portion excluding a cover according to the embodiment is completed;

FIG. 3 is a perspective view showing a configuration of the laser radar according to the embodiment in a state where the cover is attached;

FIG. 4 is a cross-sectional view showing a configuration of the laser radar according to the embodiment;

FIG. 5A is a perspective view showing a configuration of an optical system of an optical unit according to the embodiment;

FIG. 5B is a side view showing the configuration of the optical system of the optical unit according to the embodiment;

FIG. 5C is a schematic diagram showing a configuration of sensor portions of a photodetector according to the embodiment;

FIG. 6A is a top view of the laser radar according to the embodiment as viewed in a Z-axis negative direction;

FIG. 6B is a schematic diagram showing a projection angle of projection light of each optical unit according to the embodiment when each optical unit is positioned on an X-axis positive side of a rotation axis;

FIG. 7 is a circuit block diagram showing the configuration of the laser radar according to the embodiment;

FIG. 8A is a diagram schematically showing the traveling direction of reflected light reflected by an object, according to the embodiment;

FIG. 8B is a diagram schematically showing a condensed state of the reflected light reflected by the object, according to the embodiment;

FIG. 9A to FIG. 9D show simulation results of verifying a received state of reflected light in the case where each sensor portion has a square shape, according to a comparative example;

FIG. 10A to FIG. 10D show simulation results of verifying a received state of reflected light in the case where each sensor portion has a rectangular shape, according to the embodiment;

FIG. 11 is a diagram schematically showing a change in a range on an object from which reflected light is taken into one sensor portion (a beam size on an object that causes reflected light taken into one sensor portion), in accordance with the distance to the object, according to the embodiment;

FIG. 12A to FIG. 12D show simulation results of verifying a received state of reflected light in the case where each sensor portion has a trapezoidal shape, according to the embodiment;

FIG. 13A to FIG. 13D show simulation results of verifying a received state of reflected light in the case where each sensor portion has a T-shape, according to the embodiment;

FIG. 14A is a diagram showing simulation results of verifying a change in the amount of reflected light received by a normal sensor portion that should receive the reflected light, in accordance with the distance to an object, in the case where each sensor portion has a square shape (comparative example) and the case where each sensor portion has a T-shape (embodiment);

FIG. 14B is a diagram showing simulation results of verifying changes in the amounts of reflected light received by the normal sensor portion and the upper and lower sensor portions above and below the normal sensor portion, in accordance with the distance to an object, in the case where each sensor portion has a square shape (comparative example) and the case where each sensor portion has a T-shape (embodiment);

FIG. 15 is a diagram showing the dimensions of each portion of the sensor portion that are set in simulation, according to the embodiment;

FIG. 16A to FIG. 16C are each a diagram showing the shapes of sensor portions according to a modification; and

FIG. 17 is a cross-sectional view showing a configuration of a laser radar according to another modification.

It should be noted that the drawings are solely for description and do not limit the scope of the present invention by any degree.

### DESCRIPTION OF PREFERRED EMBODIMENTS

Hereinafter, an embodiment of the present invention will be described with reference to the drawings. For convenience, in each drawing, X, Y, and Z axes that are orthogonal to each other are additionally shown. The Z-axis positive direction is the height direction of a laser radar 1.

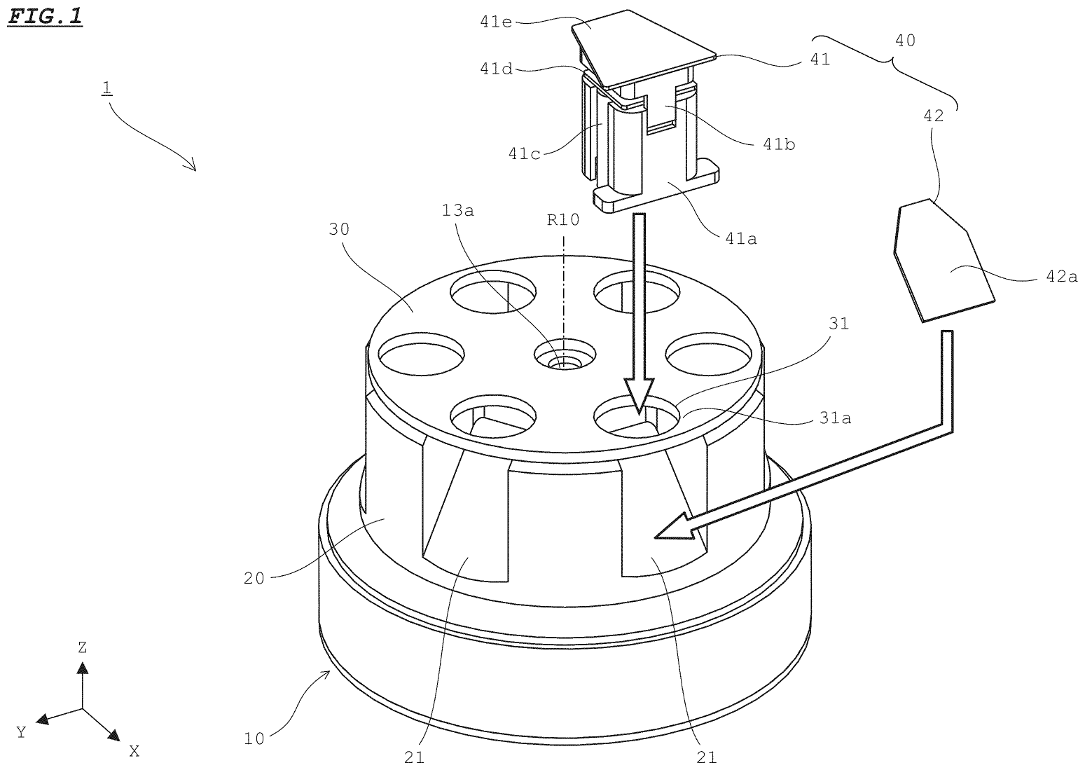

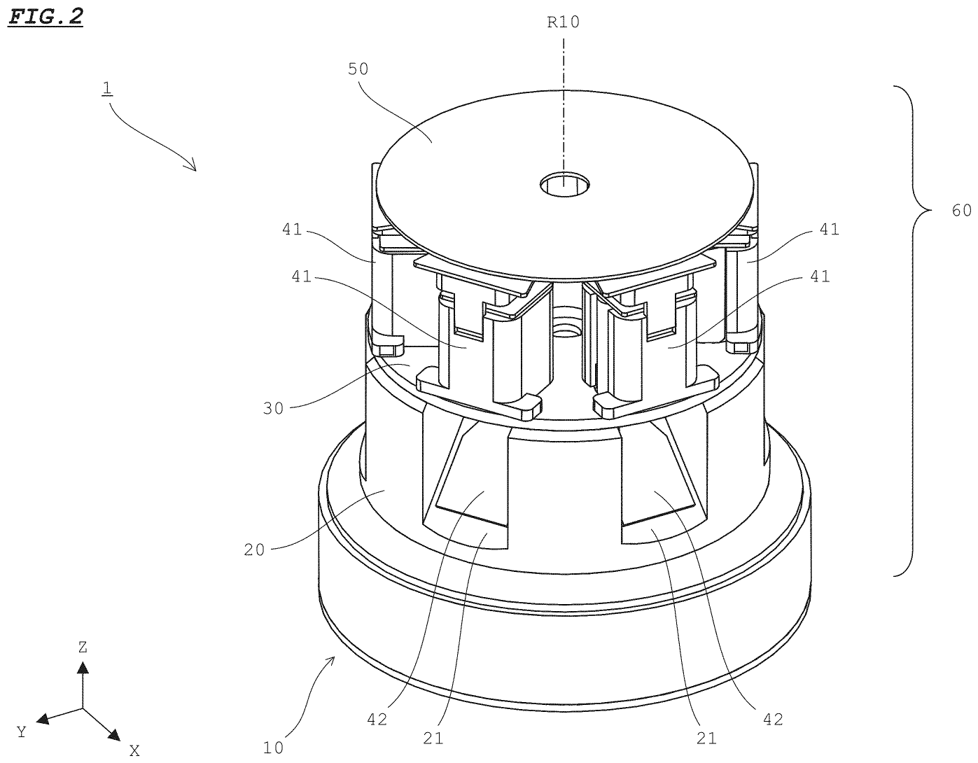

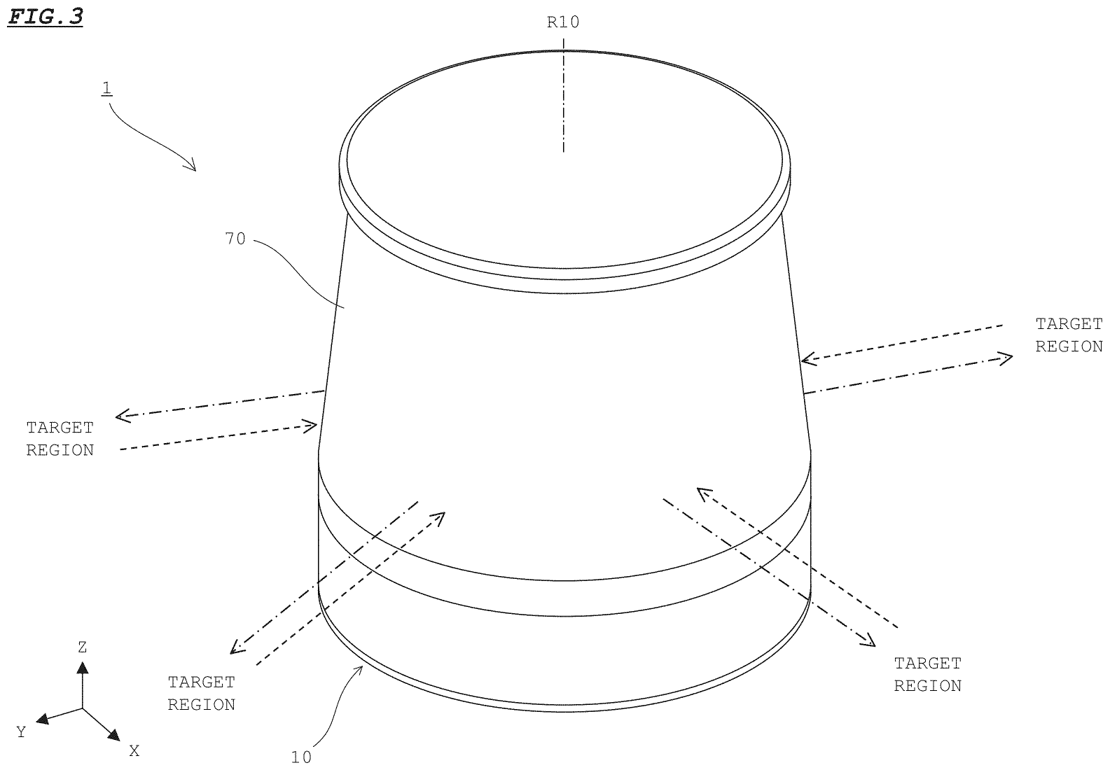

FIG. 1 is a perspective view for illustrating an assembly process of the laser radar 1. FIG. 2 is a perspective view showing a configuration of the laser radar 1 in a state where assembly of a portion excluding a cover 70 is completed. FIG. 3 is a perspective view showing a configuration of the laser radar 1 in a state where the cover 70 is attached.

As shown in FIG. 1, the laser radar 1 includes a fixing part 10 having a columnar shape, a base member 20 rotatably disposed on the fixing part 10, a disk member 30 installed on the upper surface of the base member 20, and optical units 40 installed on the base member 20 and the disk member 30.

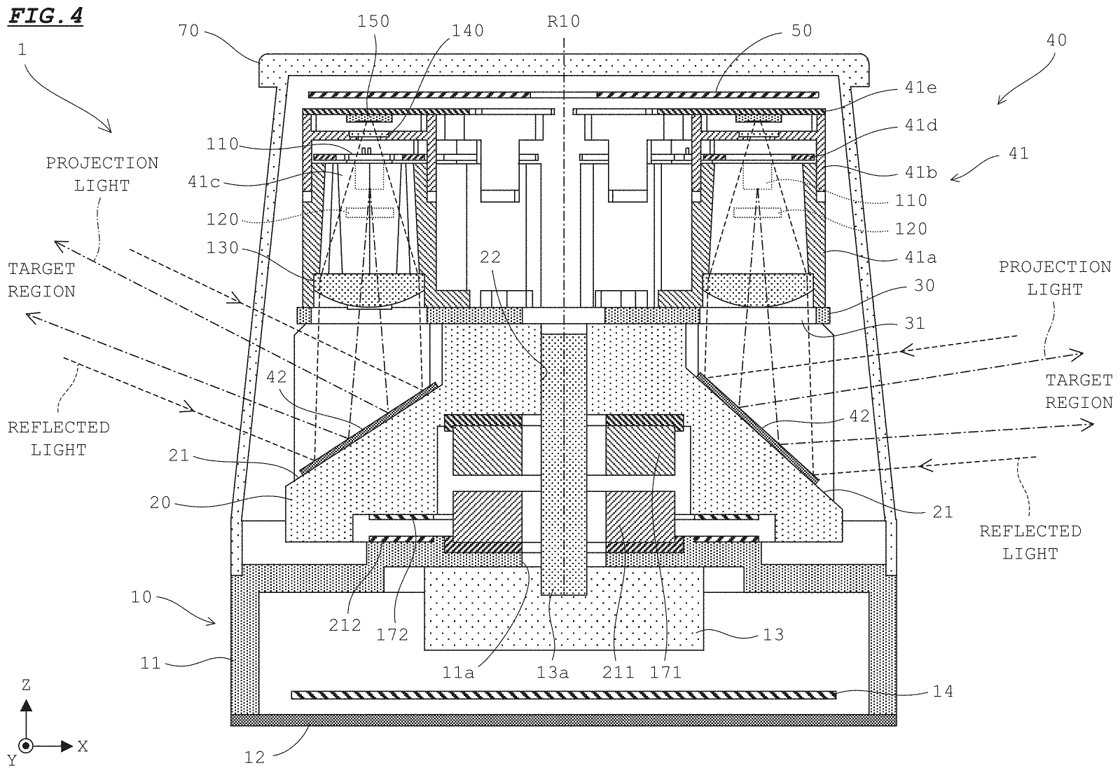

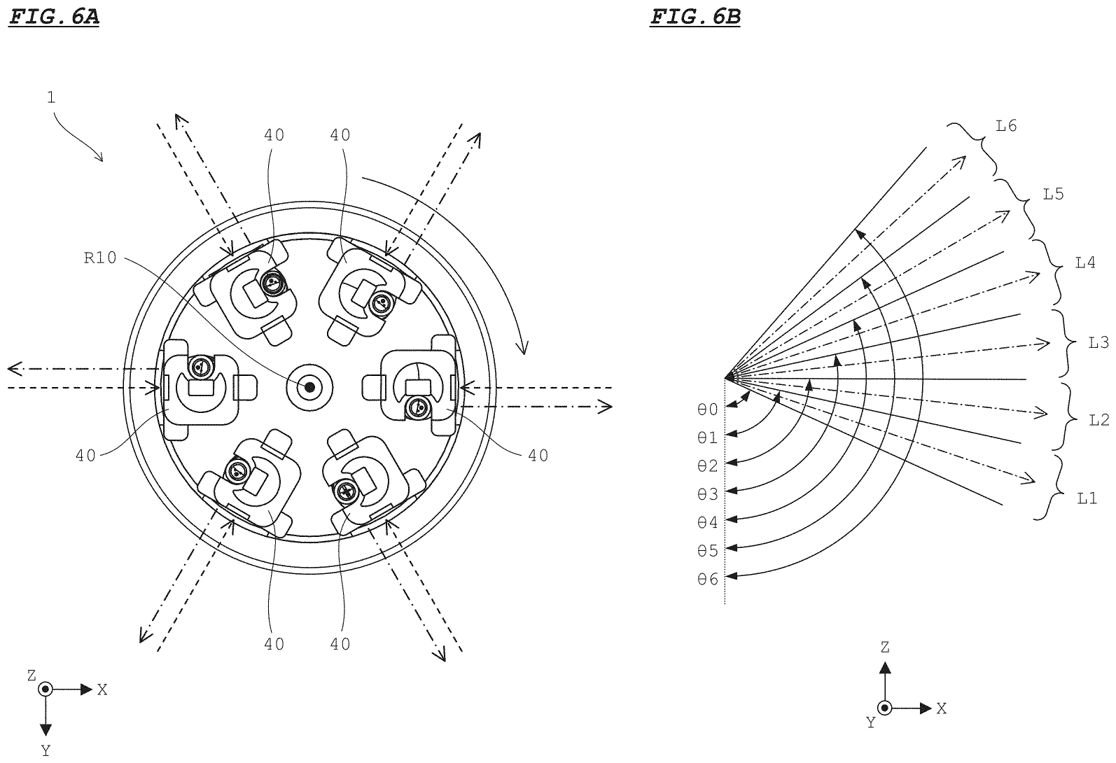

The base member 20 is installed on a drive shaft 13a of a motor 13 (see FIG. 4) provided in the fixing part 10. The base member 20 rotates about a rotation axis R10 parallel to the Z-axis direction by drive of the drive shaft 13a. The base member 20 has a columnar outer shape. In the base member 20, six installation surfaces 21 are formed at equal intervals (60° intervals) along the circumferential direction about the rotation axis R10. Each installation surface 21 is inclined with respect to a plane (X-Y plane) perpendicular to the rotation axis R10. The lateral side (direction away from the rotation axis R10) of the installation surface 21 and the upper side (Z-axis positive direction) of the installation surface 21 are open. The inclination angles of the six installation surfaces 21 are different from each other. The inclination angles of the six installation surfaces 21 will be described later with reference to FIG. 6B.

The disk member 30 is a plate member having an outer shape that is a disk shape. In the disk member 30, six circular holes 31 are formed at equal intervals (60° intervals) along the circumferential direction about the rotation axis R10. Each hole 31 penetrates the disk member 30 in the direction of the rotation axis R10 (Z-axis direction). The disk member 30 is installed on the upper surface of the base member 20 such that the six holes 31 are respectively positioned above the six installation surfaces 21 of the base member 20.

Each optical unit 40 includes a structure 41 and a mirror 42. The structure 41 includes two holding members 41a and 41b, a light blocking member 41c, and two substrates 41d and 41e. The holding members 41a and 41b and the light blocking member 41c hold each component of an optical system included in the structure 41. The holding member 41b is installed on an upper portion of the holding member 41a. The light blocking member 41c is held by the holding member 41a.

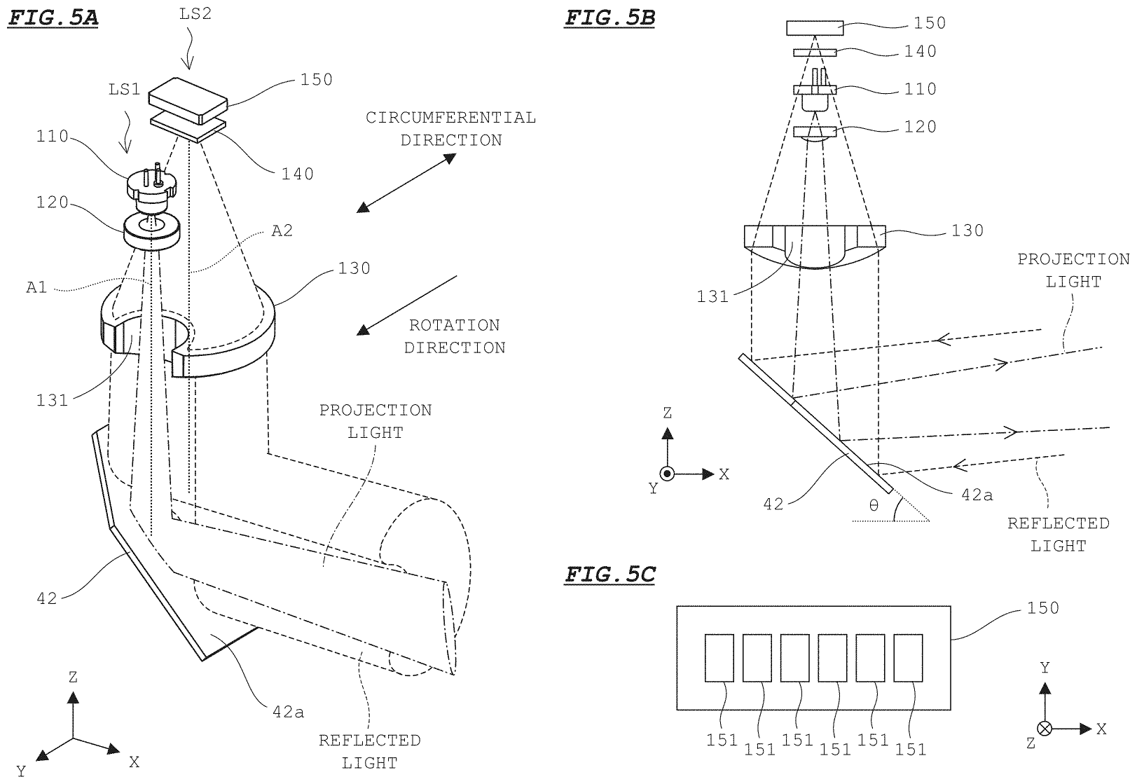

The substrates 41d and 41e are installed on the upper surfaces of the holding members 41a and 41b, respectively. The structure 41 emits laser light in the downward direction (Z-axis negative direction), and receives laser light from the lower side. The optical system included in the structure 41 will be described later with reference to FIG. 4 and FIG. 5A to FIG. 5C.

As shown in FIG. 1, the structure 41 of each optical unit 40 is installed on a surface 31a around the hole 31 from the upper side of the hole 31 with respect to the structure consisting of the fixing part 10, the base member 20, and the disk member 30. Accordingly, six optical units 40 are arranged at equal intervals (60° intervals) along the circumferential direction about the rotation axis R10. The optical units 40 do not necessarily have to be arranged at equal intervals in the circumferential direction.

The mirror 42 of each optical unit 40 is installed on the installation surface 21 of the base member 20. The mirror 42 is a plate member in which a surface installed on the installation surface 21 and a reflecting surface 42a on the side opposite to the installation surface 21 are parallel to each other. As described above, an installation region for installing one optical unit 40 is formed by the surface 31a for installing the structure 41 and the installation surface 21 which is located below the surface 31a and which is for installing the mirror 42. In the present embodiment, six installation regions are provided, and the optical unit 40 is installed on each installation region.

Subsequently, a substrate 50 is installed on the upper surfaces of the six optical units 40 as shown in FIG. 2. Accordingly, the assembly of a rotary part 60 including the base member 20, the disk member 30, the six optical units 40, and the substrate 50 is completed. The rotary part 60 rotates about the rotation axis R10 by driving the drive shaft 13a (see FIG. 4) of the motor 13 of the fixing part 10.

Then, in the state shown in FIG. 2, the cover 70 having a cylindrical shape is installed on an outer peripheral portion of the fixing part 10 so as to cover the upper side and the lateral side of the rotary part 60 as shown in FIG. 3. An opening is formed at the lower end of the cover 70, and the inside of the cover 70 is hollow. The rotary part 60 which rotates inside the cover 70 is protected by installing the cover 70. In addition, the cover 70 is made of a material that allows laser light to pass therethrough. The cover 70 is made of, for example, polycarbonate. Accordingly, the assembly of the laser radar 1 is completed.

In detecting an object by the laser radar 1, laser light (projection light) is emitted from a laser light source 110 (see FIG. 4) of each structure 41 in the Z-axis negative direction. The projection light is reflected by the mirror 42 in a direction away from the rotation axis R10. The projection light reflected by the mirror 42 passes through the cover 70 and is emitted to the outside of the laser radar 1.

As shown by alternate long and short dash lines in FIG. 3, the projection light is emitted from the cover 70 radially with respect to the rotation axis R10, and projected toward a target region located around the laser radar 1. Then, the projection light (reflected light) reflected by an object existing in the target region is incident on the cover 70 as shown by broken lines in FIG. 3, and taken into the laser radar 1. The reflected light is reflected by the mirror 42 and received by a photodetector 150 (see FIG. 4) of the structure 41.

The rotary part 60 shown in FIG. 2 rotates around the rotation axis R10. With the rotation of the rotary part 60, the optical axis of each projection light traveling from the laser radar 1 toward the target region rotates about the rotation axis R10. Along with this, the target region (scanning position of the projection light) also rotates.

The laser radar 1 determines whether or not an object exists in the target region, on the basis of whether or not the reflected light is received. In addition, the laser radar 1 measures the distance to the object existing in the target region, on the basis of the time difference (time of flight) between the timing when the projection light is projected to the target region and the timing when the reflected light is received from the target region. When the rotary part 60 rotates about the rotation axis R10, the laser radar 1 can detect objects that exist in substantially the entire range of 360 degrees around the laser radar 1.

FIG. 4 is a cross-sectional view showing a configuration of the laser radar 1.

FIG. 4 shows a cross-sectional view of the laser radar 1 shown in FIG. 3 taken at the center position in the Y-axis direction along a plane parallel to the X-Z plane. In FIG. 4, a flux of the laser light (projection light) emitted from the laser light source 110 of each optical unit 40 and traveling toward the target region is shown by an alternate long and short dash line, and a flux of the laser light (reflected light) reflected from the target region is shown by a broken line. In addition, in FIG. 4, for convenience, the positions of each laser light source 110 and each collimator lens 120 are shown by dotted lines.

As shown in FIG. 4, the fixing part 10 includes a columnar support base 11, a bottom plate 12, the motor 13, a substrate 14, a non-contact power feeding part 211, and a non-contact communication part 212.

The support base 11 is made of, for example, a resin. The lower surface of the support base 11 is closed by the bottom plate 12 having a circular dish shape. A hole 11a is formed at the center of the upper surface of the support base 11 so as to penetrate the upper surface of the support base 11 in the Z-axis direction. The upper surface of the motor 13 is located around the hole 11a on the inner surface of the support base 11. The motor 13 includes the drive shaft 13a extending in the Z-axis positive direction, and rotates the drive shaft 13a about the rotation axis R10.

The non-contact power feeding part 211 is installed around the hole 11a on the outer surface of the support base 11 along the circumferential direction about the rotation axis R10. The non-contact power feeding part 211 is composed of a coil capable of supplying power to and being supplied with power from a non-contact power feeding part 171 described later. In addition, the non-contact communication part 212 is installed around the non-contact power feeding part 211 on the outer surface of the support base 11 along the circumferential direction about the rotation axis R10. The non-contact communication part 212 is composed of a substrate on which electrodes and the like capable of wireless communication with a non-contact communication part 172 described later are arranged.

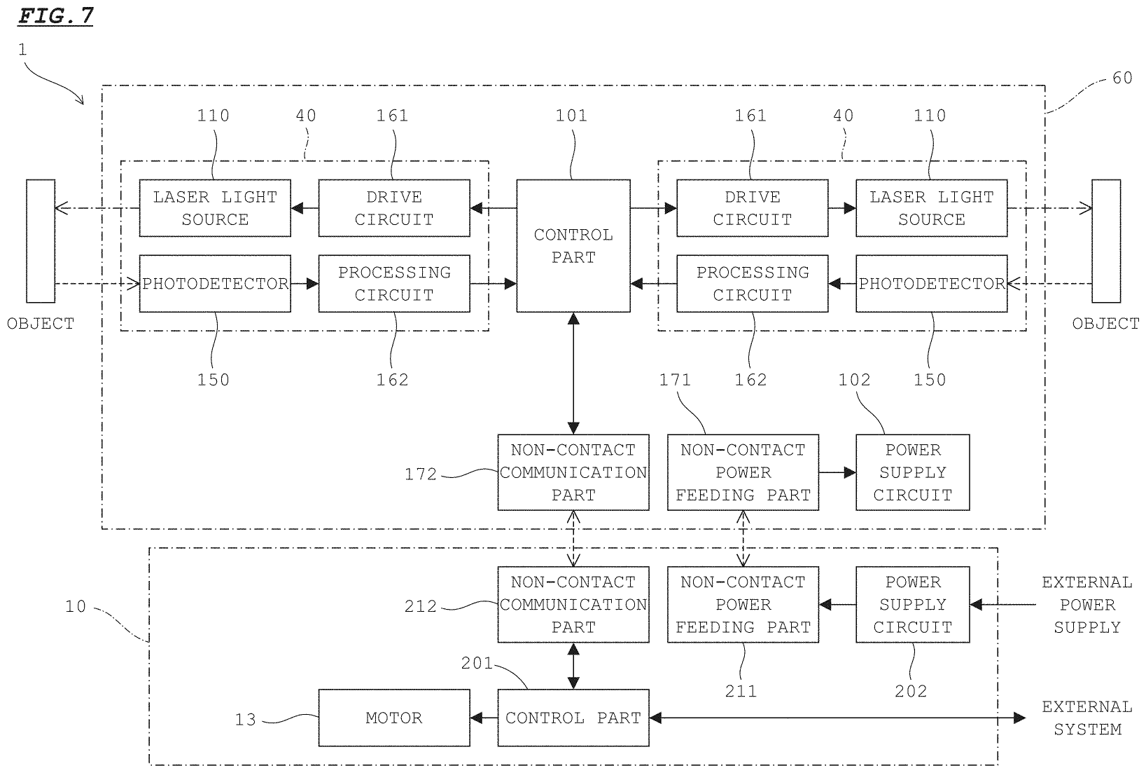

A control part 201 and a power supply circuit 202 (see FIG. 7), which will be described later, are installed on the substrate 14. The motor 13, the non-contact power feeding part 211, and the non-contact communication part 212 are electrically connected to the substrate 14.

A hole 22 is formed at the center of the base member 20 so as to penetrate the base member 20 in the Z-axis direction. By installing the drive shaft 13a of the motor 13 in the hole 22, the base member 20 is supported on the fixing part 10 so as to be rotatable about the rotation axis R10. The non-contact power feeding part 171 is installed around the hole 22 on the lower surface side of the base member 20 along the circumferential direction about the rotation axis R10. The non-contact power feeding part 171 is composed of a coil capable of supplying power to and being supplied with power from the non-contact power feeding part 211 of the fixing part 10. In addition, the non-contact communication part 172 is installed around the non-contact power feeding part 171 on the lower surface side of the base member 20 along the circumferential direction about the rotation axis R10. The non-contact communication part 172 is composed of a substrate on which electrodes and the like capable of wireless communication with the non-contact communication part 212 of the fixing part 10 are arranged.

As described with reference to FIG. 1, the six installation surfaces 21 are formed in the base member 20 along the circumferential direction about the rotation axis R10, and the mirror 42 is installed on each of the six installation surfaces 21. In addition, the disk member 30 is installed on the upper surface of the base member 20. Each optical unit 40 is installed on the upper surface of the disk member 30 such that the hole 31 of the disk member 30 and the opening formed in the lower surface of the holding member 41a coincide with each other.

The structure 41 of each optical unit 40 includes the laser light source 110, the collimator lens 120, a condensing lens 130, a filter 140, and the photodetector 150 as components of the optical system.

Holes are formed in the holding members 41a and 41b and the light blocking member 41c so as to penetrate the holding members 41a and 41b and the light blocking member 41c in the Z-axis direction. The light blocking member 41c is a tubular member. The laser light source 110 is installed on the substrate 41d installed on the upper surface of the holding member 41a, and the emission end face of the laser light source 110 is positioned inside the hole formed in the light blocking member 41c. The collimator lens 120 is positioned inside the hole formed in the light blocking member 41c, and is installed on the side wall of this hole. The condensing lens 130 is held in the hole formed in the holding member 41a. The filter 140 is held in the hole formed in the holding member 41b. The photodetector 150 is installed on the substrate 41e installed on the upper surface of the holding member 41b.

A control part 101 and a power supply circuit 102 (see FIG. 7), which will be described later, are installed on the substrate 50. The six substrates 41d, the six substrates 41e, the non-contact power feeding part 171, and the non-contact communication part 172 are electrically connected to the substrate 50.

Each laser light source 110 emits laser light (projection light) having a predetermined wavelength. The emission optical axis of the laser light source 110 is parallel to the Z-axis. The collimator lens 120 converges the projection light emitted from the laser light source 110. The collimator lens 120 is composed of, for example, an aspherical lens. The projection light converged by the collimator lens 120 is incident on the mirror 42. The projection light incident on the mirror 42 is reflected by the mirror 42 in a direction away from the rotation axis R10. Then, the projection light passes through the cover 70 and is projected to the target region.

If an object exists in the target region, the projection light projected to the target region is reflected by the object. The projection light (reflected light) reflected by the object passes through the cover 70 and is guided to the mirror 42. Then, the reflected light is reflected in the Z-axis positive direction by the mirror 42. The condensing lens 130 converges the reflected light reflected by the mirror 42.

Then, the reflected light is incident on the filter 140. The filter 140 is configured to allow light in the wavelength band of the projection light emitted from the laser light source 110 to pass therethrough and to block light in the other wavelength bands. The reflected light having passed through the filter 140 is guided to the photodetector 150. The photodetector 150 receives the reflected light and outputs a detection signal corresponding to the amount of the received light. The photodetector 150 is, for example, an avalanche photodiode.

FIG. 5A is a perspective view showing a configuration of the optical system of the optical unit 40. FIG. 5B is a side view showing the configuration of the optical system of the optical unit 40. FIG. 5C is a schematic diagram showing a configuration of sensor portions 151 of the photodetector 150.

FIG. 5A to FIG. 5C show the optical unit 40 and the photodetector 150 that are located on the X-axis positive side of the rotation axis R10 in FIG. 4. In FIG. 5A to FIG. 5C, for convenience, the optical unit 40 and the photodetector 150 that are located on the X-axis positive side of the rotation axis R10 in FIG. 4 are shown, but the other optical units 40 have the same configuration.

As shown in FIG. 5A and FIG. 5B, the laser light source 110 is a surface-emitting laser light source having a light emission surface that is longer in the X-axis direction than in the Y-axis direction. In addition, the collimator lens 120 is configured such that the curvature in the X-axis direction and the curvature in the Y-axis direction thereof are equal to each other. The laser light source 110 is installed at a position closer to the collimator lens 120 than the focal distance of the collimator lens 120. Accordingly, as shown in FIG. 5A, the projection light reflected by the mirror 42 is projected to a projection region in a slightly diffused state. In addition, a flux of the projection light reflected by the mirror 42 has a longer length in a direction (Z-axis direction) parallel to the rotation axis R10 than that in the Y-axis direction.

The reflected light from the target region is reflected in the Z-axis positive direction by the mirror 42 and is then incident on the condensing lens 130. An optical axis A1 of a projection optical system LS1 (the laser light source 110, the collimator lens 120, the mirror 42) for projecting the projection light and an optical axis A2 of a light-receiving optical system LS2 (the condensing lens 130, the filter 140, the photodetector 150, the mirror 42) for receiving the reflected light are each parallel to the Z-axis direction and are separated from each other by a predetermined distance in the circumferential direction about the rotation axis R10.

Here, in the present embodiment, the optical axis A1 of the projection optical system LS1 is included in the effective diameter of the condensing lens 130, and thus an opening 131 through which the optical axis A1 of the projection optical system LS1 passes is formed in the condensing lens 130. The opening 131 is formed on the outer side with respect to the center of the condensing lens 130, and is a cutout penetrating the condensing lens 130 in the Z-axis direction. By providing the opening 131 in the condensing lens 130 as described above, the optical axis A1 of the projection optical system LS1 and the optical axis A2 of the light-receiving optical system LS2 can be made closer to each other, and the laser light emitted from the laser light source 110 can be incident on the mirror 42 almost without being incident on the condensing lens 130.

The light blocking member 41c shown in FIG. 4 covers the optical axis A1 of the projection optical system LS1 and also extends from the position of the laser light source 110 to the lower end of the opening 131. In addition, the light blocking member 41c is fitted into the opening 131. Accordingly, the laser light emitted from the laser light source 110 can be inhibited from being incident on the condensing lens 130.

In the present embodiment, the rotary part 60 is rotated clockwise about the rotation axis R10 when viewed in the Z-axis negative direction. Accordingly, each component of the optical unit 40 located on the X-axis positive side of the rotation axis R10 shown in FIG. 5A is rotated in the Y-axis positive direction. As described above, in the present embodiment, the optical axis A2 of the light-receiving optical system LS2 is located at a position on the rear side in the rotation direction of the rotary part 60 with respect to the optical axis A1 of the projection optical system LS1.

As shown in FIG. 5B, the projection light incident on the mirror 42 is reflected in a direction corresponding to an angle θ, with respect to the X-Y plane, of the reflecting surface 42a of the mirror 42. As described above, the laser radar 1 includes the six optical units 40, and the inclination angles, with respect to the plane (X-Y plane) perpendicular to the rotation axis R10, of the installation surfaces 21 on which the mirrors 42 of the respective optical units 40 are installed are different from each other. Therefore, the inclination angles of the reflecting surfaces 42a of the six mirrors 42 respectively installed on the six installation surfaces 21 are also different from each other. Therefore, the projection lights reflected by the respective mirrors 42 are projected to scanning positions different from each other in the direction (Z-axis direction) parallel to the rotation axis R10.

As shown in FIG. 5C, the photodetector 150 includes the six sensor portions 151 on the Z-axis negative side. The six sensor portions 151 are arranged adjacently in a line in the X-axis direction. The direction in which the six sensor portions 151 are arranged corresponds to the Z-axis direction of the scanning range (direction parallel to the rotation axis R10). The six sensor portions 151 are arranged in a direction substantially perpendicular to the separation direction of the optical axes A1 and A2.

The six sensor portions 151 are configured by individually arranging sensors on the incident surface of the photodetector 150. Alternatively, the sensor portions 151 may be formed by arranging one sensor on the entire incident surface of the photodetector 150 and forming a mask on the upper surface of the sensor such that only the arrangement region of each sensor portion 151 is exposed.

The reflected light is incident on the six sensor portions 151 from six division regions into which the target region is divided in the Z-axis direction. Therefore, an object existing in each division region can be detected on the basis of a detection signal from each sensor portion 151. The resolution of object detection in the target region is increased in the Z-axis direction by increasing the number of sensor portions 151.

FIG. 6A is a top view of the laser radar 1 as viewed in the Z-axis negative direction. In FIG. 6A, for convenience, the cover 70, the substrate 50, the holding member 41b, and the substrates 41d and 41e are not shown.

The six optical units 40 rotate about the rotation axis R10. At this time, the six optical units 40 project the projection light in directions away from the rotation axis R10 (radially as viewed in the Z-axis direction). While rotating at a predetermined speed, the six optical units 40 project the projection light to the target region, and receive the reflected light from the target region. Accordingly, object detection is performed over the entire circumference (360°) around the laser radar 1.

FIG. 6B is a schematic diagram showing a projection angle of the projection light of each optical unit 40 when each optical unit 40 is positioned on the X-axis positive side of the rotation axis R10.

As described above, the installation angles of the six mirrors 42 are different from each other. Accordingly, the angles of six fluxes L1 to L6 of the projection light emitted from the six optical units 40, respectively, are also different from each other. In FIG. 6B, the optical axes of the six fluxes L1 to L6 are shown by alternate long and short dash lines. Angles θ0 to θ6 indicating the angle ranges of the fluxes L1 to L6 are angles with respect to the direction (Z-axis direction) parallel to the rotation axis R10.

In the present embodiment, the angles θ0 to θ6 are set such that the fluxes next to each other substantially adjoin to each other. That is, the distribution ranges of the fluxes L1, L2, L3, L4, L5, and L6 have an angle θ0-θ1, an angle θ1-θ2, an angle θ2-θ3, an angle θ3-θ4, an angle θ4-θ5, and an angle θ5-θ6. Accordingly, the projection lights from the respective optical units 40 are projected to scanning positions adjoining to each other in the direction (Z-axis direction) parallel to the rotation axis R10.

FIG. 7 is a circuit block diagram showing the configuration of the laser radar 1.

The laser radar 1 includes the control part 101, the power supply circuit 102, a drive circuit 161, a processing circuit 162, the non-contact power feeding part 171, the non-contact communication part 172, the control part 201, the power supply circuit 202, the non-contact power feeding part 211, and the non-contact communication part 212 as components of circuitry. The control part 101, the power supply circuit 102, the drive circuit 161, the processing circuit 162, the non-contact power feeding part 171, and the non-contact communication part 172 are disposed in the rotary part 60. The control part 201, the power supply circuit 202, the non-contact power feeding part 211, and the non-contact communication part 212 are disposed in the fixing part 10.

The power supply circuit 202 is connected to an external power supply, and power is supplied from the external power supply to each component of the fixing part 10 via the power supply circuit 202. The power supplied to the non-contact power feeding part 211 is supplied to the non-contact power feeding part 171 in response to the rotation of the rotary part 60. The power supply circuit 102 is connected to the non-contact power feeding part 171, and the power is supplied from the non-contact power feeding part 171 to each component of the rotary part 60 via the power supply circuit 102.

The control parts 101 and 201 each include an arithmetic processing circuit and a memory, and are each composed of, for example, an FPGA or MPU. The control part 101 controls each component of the rotary part 60 according to a predetermined program stored in the memory thereof, and the control part 201 controls each component of the fixing part 10 according to a predetermined program stored in the memory thereof. The control part 101 and the control part 201 are communicably connected to each other via the non-contact communication parts 172 and 212.

The control part 201 is communicably connected to an external system. The external system is, for example, an intrusion detection system, a car, a robot, or the like. The control part 201 drives each component of the fixing part 10 in accordance with the control from the external system, and transmits a drive instruction to the control part 101 via the non-contact communication parts 212 and 172. The control part 101 drives each component of the rotary part 60 in accordance with the drive instruction from the control part 201, and transmits a detection signal to the control part 201 via the non-contact communication parts 172 and 212.

The drive circuit 161 and the processing circuit 162 are provided in each of the six optical units 40. The drive circuit 161 drives the laser light source 110 in accordance with the control from the control part 101. The processing circuit 162 performs processing such as amplification and noise removal on detection signals inputted from the sensor portions 151 of the photodetector 150, and outputs the resultant signals to the control part 101.

In the detection operation, while controlling the motor 13 to rotate the rotary part 60 at a predetermined rotation speed, the control part 201 controls the six drive circuits 161 to emit laser light (projection light) from each laser light source 110 at a predetermined rotation angle at a predetermined timing. Accordingly, the projection light is projected from the rotary part 60 to the target region, and the reflected light is received by the sensor portions 151 of the photodetector 150 of the rotary part 60.

The control part 201 determines whether or not an object exists in the target region, on the basis of detection signals outputted from the sensor portions 151. In addition, the control part 201 measures the distance to the object existing in the target region, on the basis of the time difference (time of flight) between the timing when the projection light is projected and the timing when the reflected light is received from the target region.

Meanwhile, in the above configuration, the optical axis A1 of the projection optical system LS1 and the optical axis A2 of the light-receiving optical system LS2 are separated from each other as shown in FIG. 5A, so that a condensed spot of the reflected light condensed on the light receiving surface of the photodetector 150 moves in accordance with the distance to the object.

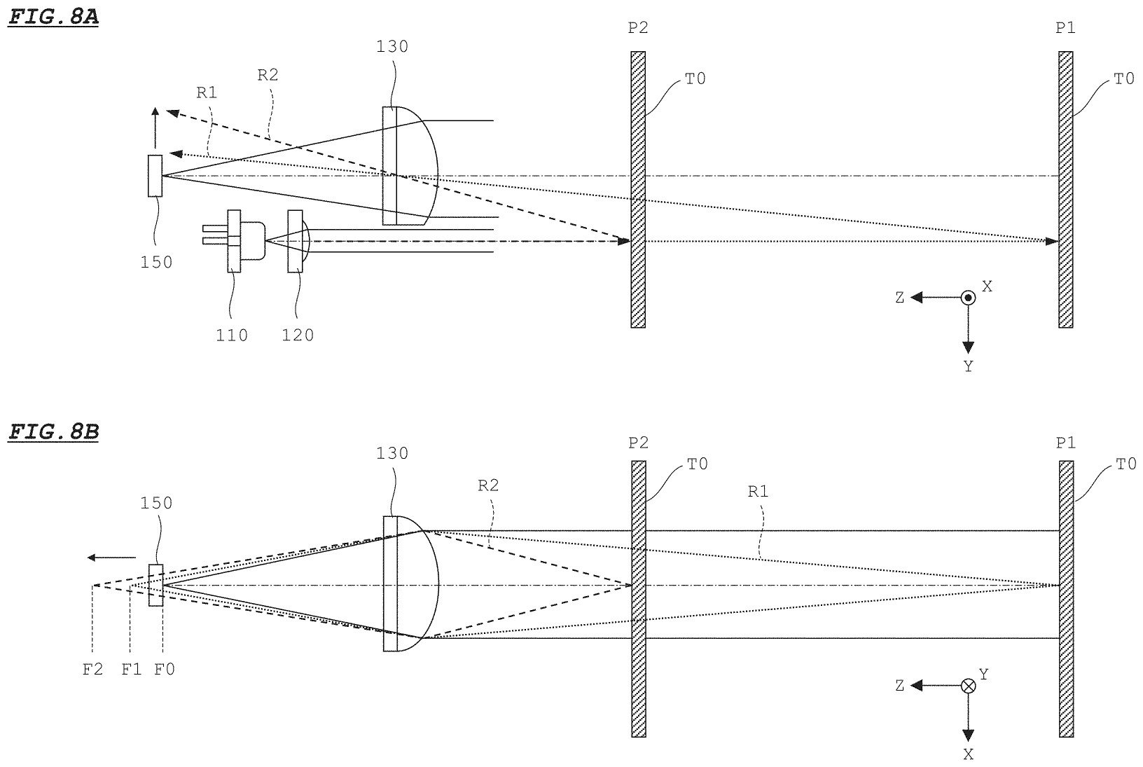

FIG. 8A is a diagram when the traveling direction of reflected light reflected by an object is viewed from the X-axis positive side, and FIG. 8B is a diagram when a condensed state of the reflected light reflected by the object is viewed from the Y-axis negative side. For convenience, in FIG. 8A, the condensing lens 130 is shown in a state where a portion corresponding to the opening 131 on the Y-axis positive side of the condensing lens 130 is cut off.

As shown in FIG. 8A and FIG. 8B, the condensing lens 130 is configured to condense reflected light (parallel light) incident thereon from infinity along the optical axis thereof, onto the light receiving surface of the photodetector 150. At this time, when the reflected light is incident on the condensing lens 130 with a width equal to the effective diameter of the condensing lens 130, the reflected light is condensed on the photodetector 150 over all of the plurality of sensor portions 151. That is, as shown in FIG. 5A, projection light is projected from the projection optical system LS1 with a beam shape that is long in the Z-axis direction. Therefore, when the reflected light is incident with a width equal to the effective diameter of the condensing lens 130, the beam shape of the reflected light condensed by the condensing lens 130 is a beam shape that is long in the X-axis direction on the light receiving surface of the photodetector 150. The plurality of sensor portions 151 are disposed so as to be aligned in the X-axis direction. When the reflected light is incident with a width equal to the effective diameter of the condensing lens 130, the reflected light condensed by the condensing lens 130 is condensed over all of the plurality of sensor portions 151.

Here, as shown in FIG. 8A, when an object T0 is present at a position P1, reflected light R1 reflected by the object T0 is incident on the condensing lens 130 from a direction inclined with respect to the optical axis of the condensing lens 130. Therefore, the condensed position of the reflected light R1 on the light receiving surface of the photodetector 150 shifts in the Y-axis negative direction from the condensed position of reflected light that is incident thereon from infinity. When the object T0 exists at a position P2 closer than the position P1, the amount of shift in the Y-axis negative direction of the condensed position of reflected light R2 on the light receiving surface becomes larger.

As shown in FIG. 8B, when the object T0 is present at the position P1, the reflected light R1 reflected by the object T0 is incident on the condensing lens 130 in a state where the reflected light R1 spreads from the parallel light. Therefore, a condensed position F1 of the reflected light R1 condensed on the light receiving surface of the photodetector 150 shifts in the Z-axis positive direction from a condensed position F0 of reflected light that is incident as parallel light thereon from infinity. When the object T0 exists at the position P2 closer than the position P1, the amount of shift in the Z-axis positive direction of a condensed position F2 of the reflected light R2 on the light receiving surface becomes larger.

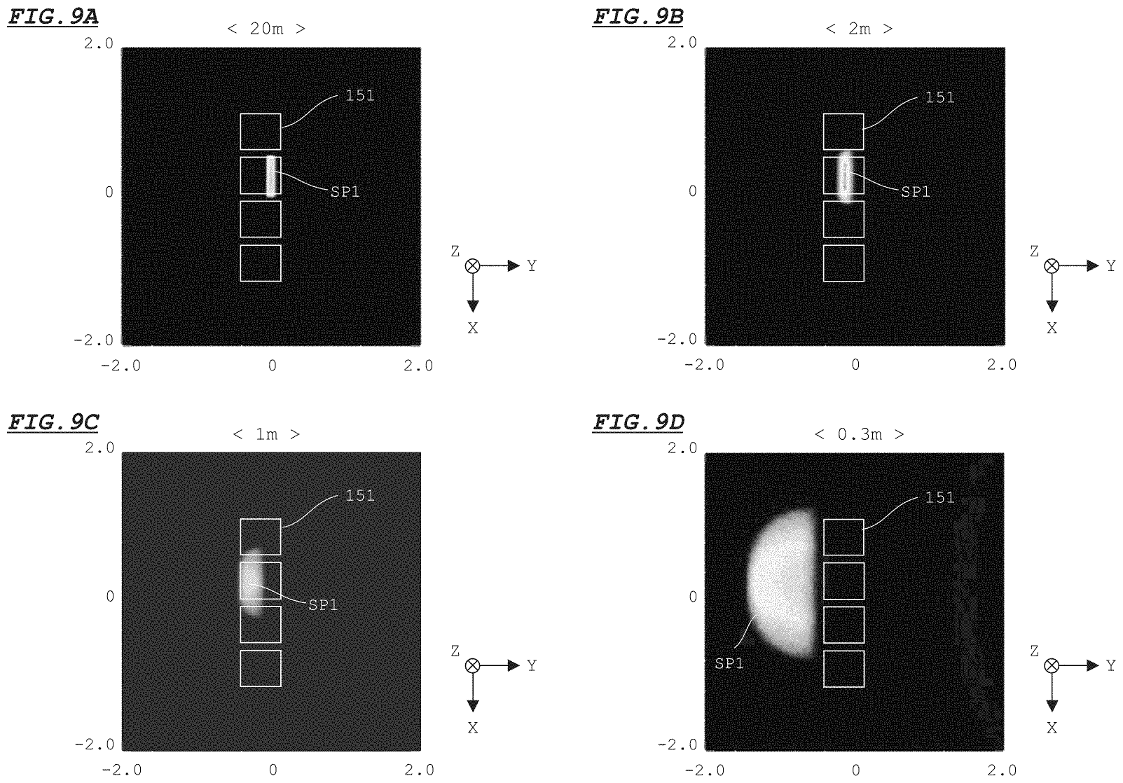

FIG. 9A to FIG. 9D show simulation results of verifying a received state of reflected light in the case where each sensor portion 151 has a square shape (comparative example).

The conditions for this verification are set as follows.

Effective diameter of condensing lens 130: 18 mm

Focal distance of condensing lens 130: 31.5 mm

Sizes of sensor portions 151: width 0.45 mm×height 0.45 mm

Pitches of sensor portions 151: 0.55 mm

Amount of displacement between optical axes A1 and A2: 11.5 mm

The optical axis of the condensing lens 130 is assumed to perpendicularly penetrate the gap between the second and third sensor portions 151 from the top.

Under these conditions, the state of the reflected light condensed on the second sensor portion 151 from the top is obtained by simulation. Here, it is assumed that the angle of view (light intake angle) of each sensor portion 151 is 1°, and it is assumed that an object exists only in the range of the angle of view of 1° of the second sensor portion 151 from the top. The size of the object at the position of each distance is changed according to the spread of the angle of view of 1°. That is, it is assumed that the object exists in the entire range of the angle of view at each distance position. In addition, the distance measurement range is assumed to be 3 to 20 m. FIG. 9A to FIG. 9D show simulation results in the case where the distances to the object are 20 m, 2 m, 1 m, and 0.3 m, respectively.

As shown in FIG. 9A to FIG. 9D, a condensed spot SP1 of the reflected light moves in the Y-axis negative direction as the distance to the object becomes shorter. In this verification example, in the range where the distance to the object is 20 to 1 m, the condensed spot SP1 of the reflected light is located on the sensor portions 151. However, when the distance to the object is 0.3 m, the condensed spot SP1 of the reflected light is outside the sensor portions 151. More specifically, when the distance to the object is about 0.5 m which is slightly longer than 0.3 m, the condensed spot SP1 is outside the sensor portions 151. Therefore, in the case where each sensor portion 151 has a square shape having a size of 0.55 mm in height and width, when the distance to the object is shorter than about 0.5 m, the object cannot be detected.

Moreover, as shown in FIG. 9A to FIG. 9D, the size of the condensed spot SP1 of the reflected light gradually increases due to the focus shift as the distance to the object becomes shorter. Therefore, when the distance to the object becomes short, the condensed spot SP1 of the reflected light is located not only on the second sensor portion 151 from the top but also on the upper and lower sensor portions 151 above and below the second sensor portion 151. In this verification example, when the distance to the object is 2 m, the condensed spot SP1 is slightly located on the upper and lower sensor portions 151, and when the distance to the object is 1 m, the sizes of the portions of the condensed spot SP1 located on the upper and lower sensor portions 151 are increased.

As described above, in the case where the optical axis A1 of the projection optical system LS1 and the optical axis A2 of the light-receiving optical system LS2 are separated from each other, particularly when the distance to the object is short, a problem arises in object detection. That is, when the distance to the object is short, the condensed spot SP1 of the reflected light is outside the sensor portions 151, causing a problem that the object cannot be detected. In addition, when the distance to the object is short, the condensed spot SP1 of the reflected light is located on the normal sensor portion 151 and also on the sensor portions 151 adjacent thereto, causing a problem that the range in which the object exists is detected as a range slightly wider than the normal range.

In the present embodiment, of these two problems, first, in order to solve the former problem, the shape of each sensor portion 151 is a rectangular shape that is long in the Y-axis direction, that is, in the separation direction of the optical axis A1 of the projection optical system LS1 and the optical axis A2 of the light-receiving optical system LS2.

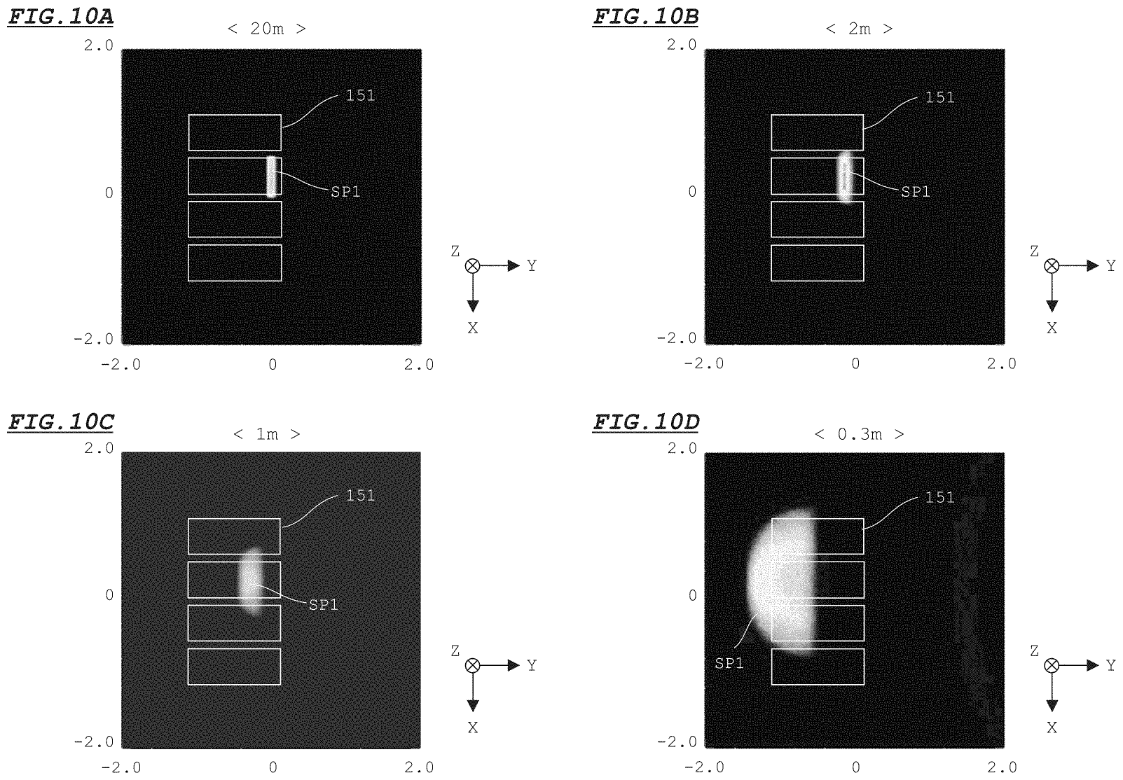

FIG. 10A to FIG. 10D show simulation results of verifying a received state of reflected light in the case where each sensor portion 151 has a rectangular shape (embodiment).

The conditions for this verification are the same as the verification conditions in FIG. 9A to FIG. 9D, except for the shape of each sensor portion 151. The shape of each sensor portion 151 is set as follows.

Sizes of sensor portions 151: width 1 mm×height 0.45 mm

As shown in FIG. 10A to FIG. 10D, when the shape of each sensor portion 151 is set to a rectangular shape of the above size, the condensed spot SP1 of the reflected light can be located on the second sensor portion 151 from the top in a range where the distance to the object is 20 to 0.3 m. That is, in this configuration, as shown in FIG. 10D, even when the distance to the object is 0.3 m, the reflected light can be incident on the second sensor portion 151 from the top, so that the object can be properly detected. Therefore, by setting the shape of each sensor portion 151 to a rectangular shape that is long in the Y-axis direction, that is, in the separation direction of the optical axis A1 of the projection optical system LS1 and the optical axis A2 of the light-receiving optical system LS2, the range where the object can be detected can be expanded as compared with the case of FIG. 9A to FIG. 9D (comparative example).

In the configuration of FIG. 10A to FIG. 10D, the amount of the reflected light leaking to the upper and lower sensor portions 151 above and below the second sensor portion 151 increases as the distance to the object becomes shorter. Therefore, if the distance to the object is short, it may be erroneously detected that the object also exists at positions corresponding to the upper and lower sensor portions 151.

However, as the distance to the object is shorter, a range on the object from which the reflected light is taken into one sensor portion 151 is smaller. Therefore, even if it is erroneously detected that the object also exists at the positions corresponding to the upper and lower sensor portions 151, the object detection range is only slightly wider than the normal range.

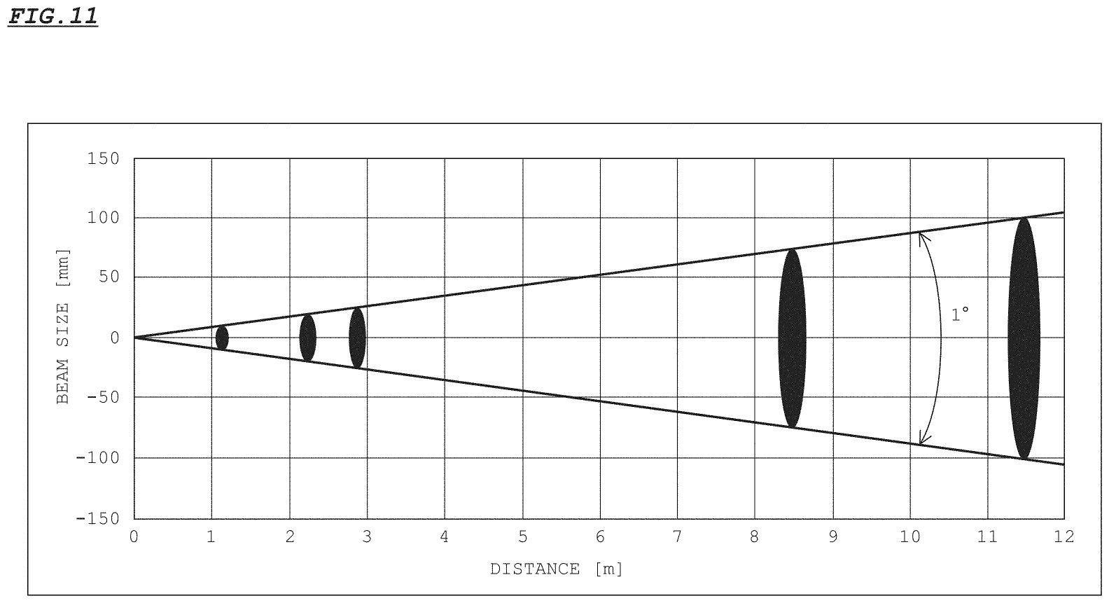

FIG. 11 is a diagram schematically showing a change in the range on the object from which the reflected light is taken into one sensor portion 151 (a beam size on the object which causes reflected light taken into one sensor portion 151), in accordance with the distance to the object in the case where the angle of view of one sensor portion 151 is 1°.

As shown in FIG. 11, as the distance to the object becomes shorter, the beam size on the object corresponding to one sensor portion 151 becomes smaller. For example, when the distance to the object is 0.3 m, the beam size on the object corresponding to one sensor portion 151 is about several millimeters. Therefore, as shown in FIG. 10D, even if, due to leak of the reflected light to the upper and lower sensor portions 151 above and below the second sensor portion 151, it is erroneously detected that the object also exists at the positions corresponding to these upper and lower sensor portions 151, the object detection range is only slightly expanded by a few millimeters from the normal range.

Therefore, in the case where each sensor portion 151 has a rectangular shape as shown in FIG. 10A to FIG. 10D, when the distance to the object is about 0.3 m, even if the reflected light leaks to the upper and lower sensor portions 151 above and below the second sensor portion 151 and it is erroneously detected that the object exists at the positions corresponding to these sensor portions 151, it is considered that the influence of this erroneous detection on the normal object detection is not large.

However, in order to detect the position of the object more accurately, it is preferable to prevent the reflected light from leaking to the upper and lower sensor portions 151 as much as possible. That is, it is preferable to also solve the latter problem of the above two problems.

In order to solve this problem, in the present embodiment, the shape of each sensor portion 151 is further adjusted such that the portion on the Y-axis negative side is narrower than the portion on the Y-axis positive side. Accordingly, the leak of the reflected light to the upper and lower sensor portions 151 can be suppressed, so that the position where the object exists can be detected more accurately. This configuration will be described below.

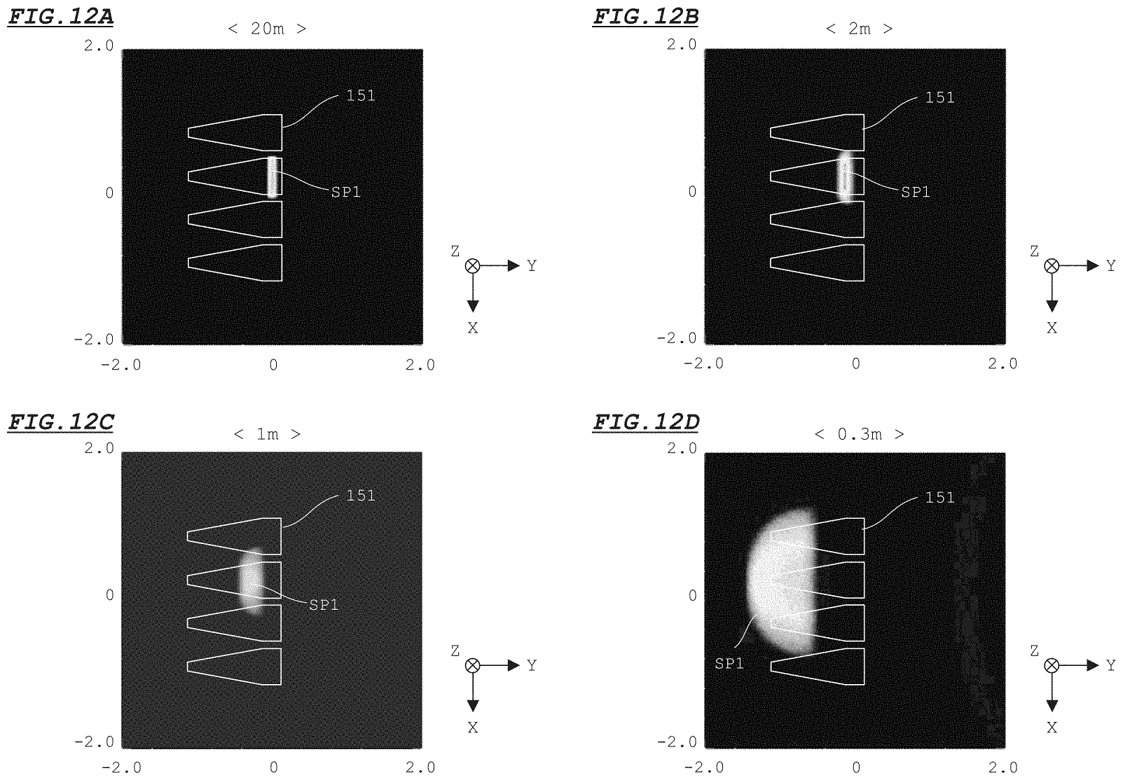

FIG. 12A to FIG. 12D show simulation results of verifying a received state of reflected light in the case where each sensor portion 151 has a trapezoidal shape (embodiment).

The conditions for this verification are the same as the verification conditions in FIG. 9A to FIG. 9D, except for the shape of each sensor portion 151.

As shown in FIG. 12C, in the case where the shape of each sensor portion 151 is a trapezoidal shape, the amount of the reflected light leaking to the upper and lower sensor portions 151 when the distance to the object is 1 m is reduced. In this case as well, the reflected light leaks slightly to the upper and lower sensor portions 151, but since the amount of the leak is small, the detection signals outputted from the upper and lower sensor portions 151 are considerably small. Therefore, by removing the detection signals outputted from the upper and lower sensor portions 151 by a predetermined threshold, it is possible to prevent erroneous detection that the object exists in the ranges corresponding to the upper and lower sensor portions 151.

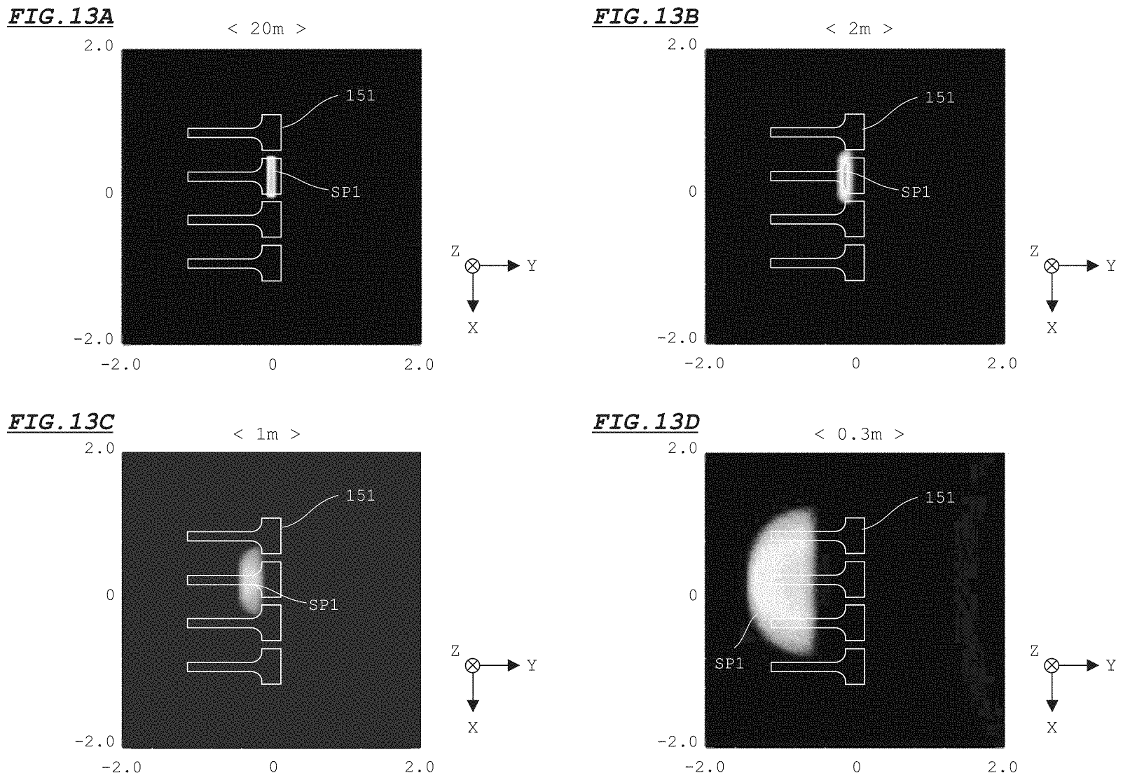

FIG. 13A to FIG. 13D show simulation results of verifying a received state of reflected light in the case where each sensor portion 151 has a T-shape (embodiment).

The conditions for this verification are the same as the verification conditions in FIG. 9A to FIG. 9D, except for the shape of each sensor portion 151.

As shown in FIG. 13C, in the case where the shape of each sensor portion 151 is a T-shape, the amount of the reflected light leaking to the upper and lower sensor portions 151 when the distance to the object is 1 m is eliminated. Therefore, when the distance to the object is 1 m, it is possible to prevent erroneous detection that the object exists in the ranges corresponding to the upper and lower sensor portions 151. In addition, as shown in FIG. 13B, when the distance to the object is 2 m, the reflected light leaks slightly to the upper and lower sensor portions 151, but the amount of the leak is considerably small. Therefore, in this case as well, by removing the detection signals outputted from the upper and lower sensor portions 151 by a predetermined threshold, it is possible to prevent erroneous detection that the object exists in the ranges corresponding to the upper and lower sensor portions 151.

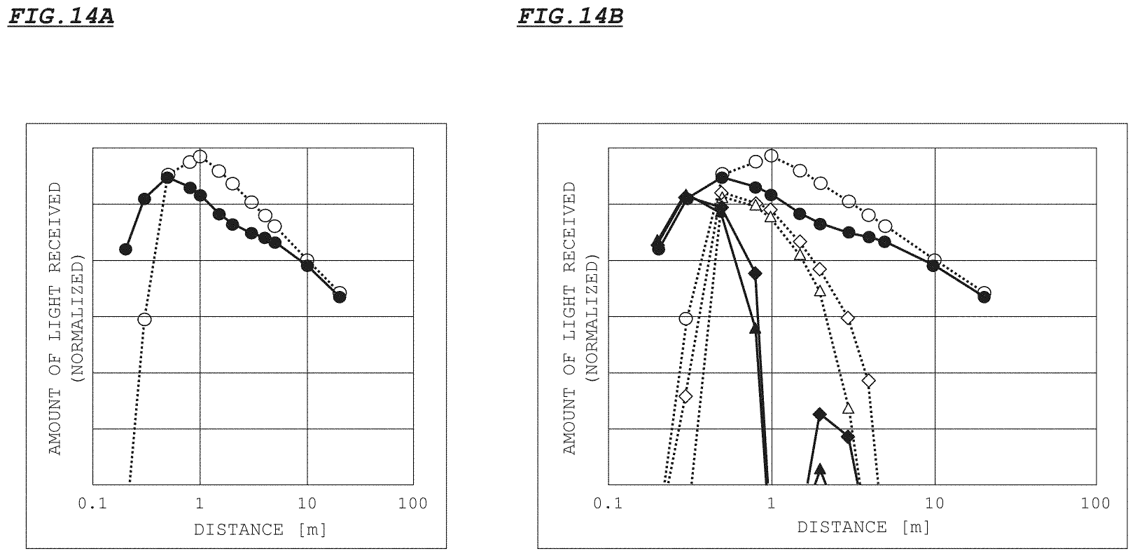

FIG. 14A is a diagram showing simulation results of verifying a change in the amount of reflected light received by the second sensor portion 151 in accordance with the distance to an object, in the case where each sensor portion 151 has a square shape (comparative example) and the case where each sensor portion 151 has a T-shape (embodiment). FIG. 14B is a diagram showing simulation results of verifying changes in the amounts of reflected light received by the second sensor portion 151 and the sensor portions above and below the second sensor portion 151, in accordance with the distance to an object, in the case where each sensor portion 151 has a square shape (comparative example) and the case where each sensor portion 151 has a T-shape (embodiment).

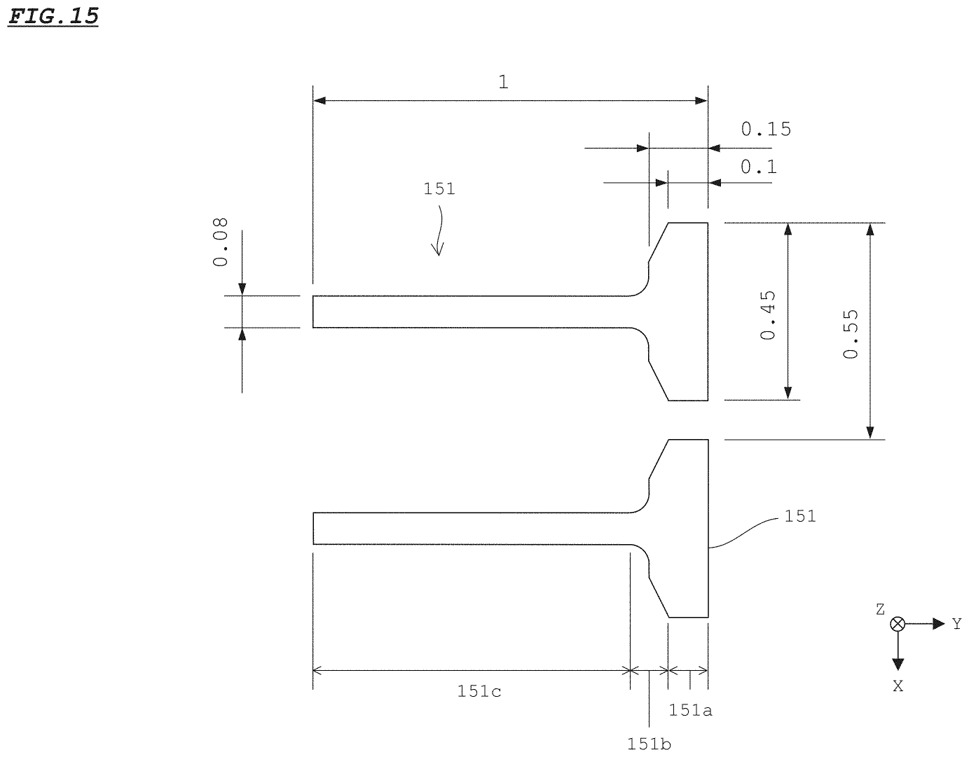

In these verifications, the dimensions of each part of each sensor portion 151 in the case where each sensor portion 151 has a T-shape (embodiment) are set to the dimensions added to the sensor portion 151 in the upper part of FIG. 15. The unit of the dimensions of each part is mm (millimeter). Similar to the above verification, the pitches of the sensor portions 151 are set to 0.55 mm.

Moreover, as shown in the lower part of FIG. 15, each sensor portion 151 of the embodiment has a shape having: a portion 151a having a large width; a portion 151b having a gradually decreasing width; and a portion 151c having a small width. The portion 151b has a shape having a linear portion whose width linearly decreases and an arc portion whose width decreases in an arc shape. The dimensions in the case where each sensor portion 151 has a square shape (comparative example) are the same as those in the case of FIG. 9A to FIG. 9D. The other verification conditions are the same as in the case of FIG. 9A to FIG. 9D.

In FIG. 14A and FIG. 14B, the vertical axis is normalized, and the horizontal axis is a logarithmic axis. In FIG. 14A, a broken line graph in which white circles are plotted shows the verification result in the case where the shape of each sensor portion 151 is a square shape, and a solid line graph in which black circles are plotted shows the verification result in the case where the shape of each sensor portion 151 is a T-shape.

As shown in FIG. 14A, in the case where each sensor portion 151 has a square shape (comparative example), the amount of light received by the second sensor portion 151 is greatly reduced from around the point where the distance to the object becomes less than 1 m, and the amount of light received reaches almost zero around the point where the distance to the object is 0.3 m. On the other hand, in the case where each sensor portion 151 has a T-shape (embodiment), the amount of light received by the second sensor portion 151 is maintained high even when the distance to the object is less than 1 m, and a sufficient amount of received light is ensured even when the distance to the object is about 0.3 m. From this verification, it is confirmed that in the case where the shape of each sensor portion 151 is a T-shape (embodiment), the object can be properly detected in the range where the distance to the object is 0.3 to 20 m (distance measurement range).

In FIG. 14B, three broken line graphs show the amounts of light received by the second sensor portion 151 and the upper and lower sensor portions 151 (the first and third sensor portions 151) above and below the second sensor portion 151 in the case where the shape of each sensor portion 151 is a square shape (comparative example). Of these graphs, the broken line graph in which white circles are plotted shows the amount of light received by the second sensor portion 151, the broken line graphs in which white triangles and white squares are plotted show the amounts of light received by the upper and lower sensor portions 151 above and below the second sensor portion 151, respectively.

Moreover, in FIG. 14B, three solid line graphs show the amounts of light received by the second sensor portion 151 and the upper and lower sensor portions 151 above and below the second sensor portion 151 in the case where the shape of each sensor portion 151 is a T-shape (embodiment). Of these graphs, the solid line graph in which black circles are plotted shows the amount of light received by the second sensor portion 151, and the solid line graphs in which black triangles and black squares are plotted show the amounts of light received by the upper and lower sensor portions 151 above and below the second sensor portion 151, respectively.

As shown in FIG. 14B, in the case where the shape of each sensor portion 151 is a square shape (comparative example), the reflected light begins to leak to the upper and lower sensor portions 151 around the point where the distance to the object becomes less than 6 m, and a larger amount of the reflected light than the amount of the reflected light received normally when the distance is 20 m leaks to the upper and lower sensor portions 151 in the range where the distance to the object is about 2 to 0.5 m. Therefore, in the case where the shape of each sensor portion 151 is a square shape (comparative example), it can be seen that in the range where the distance to the object is about 2 to 0.5 m, it is erroneously detected that the object exists in the ranges corresponding to the upper and lower sensor portions 151.

On the other hand, in the case where the shape of each sensor portion 151 is a T-shape (embodiment), the reflected light begins to leak to the upper and lower sensor portions 151 around the point where the distance to the object becomes less than 1 m, and a larger amount of the reflected light than the amount of the reflected light received normally when the distance is 20 m leaks to the upper and lower sensor portions 151 in the range where the distance to the object is about 0.9 to 0.3 m. Therefore, in the case where the shape of each sensor portion 151 is a T-shape (embodiment), it can be seen that in the range where the distance to the object is about 0.9 to 0.3 m, it is erroneously detected that the object exists in the ranges corresponding to the upper and lower sensor portions 151.

However, the distance range (0.9 to 0.3 m) where the object is erroneously detected in the case where the shape of each sensor portion 151 is a T-shape (embodiment) is significantly narrower than the distance range (2 to 0.5 m) of false detection in the case where the shape of each sensor portion 151 is a square shape (comparative example). In addition, as described above, when the distance to the object is short, even if it is erroneously detected that the object exists at the positions corresponding to the upper and lower sensor portions 151, the object detection range is only slightly expanded from the normal range. Therefore, it is confirmed that in the case where the shape of each sensor portion 151 is a T-shape (embodiment), the accuracy of object detection can be remarkably improved as compared with the case where the shape of each sensor portion 151 is a square shape (comparative example).

In the verification result of FIG. 14B, it can be seen that the reflected light leaks to the upper and lower sensor portions 151 in the range where the distance to the object is around 2 m. However, since the amount of this leak is considerably smaller than the amount of reflected light normally received when the distance to the object is 20 m, the detection signals due to this leak can be removed by setting a threshold. Therefore, even if the reflected light slightly leaks to the upper and lower sensor portions 151 in this range, the accuracy of object detection does not decrease due to this leak.

### Effects of Embodiment

According to the present embodiment, the following effects are achieved.

Since the photodetector 150 includes the plurality of sensor portions 151, an object can be detected in each division region, corresponding to each sensor portion 151, on the target region on the basis of the output from each sensor portion 151. In addition, since the plurality of sensor portions 151 are aligned in the direction perpendicular to the separation direction of the optical axes A1 and A2, the condensed spot SP1 of the reflected light moves in the direction perpendicular to the alignment direction of the sensor portions 151 in accordance with a change in the distance to the object. Therefore, even if the distance to the object changes, the object can be properly detected in each division region. Furthermore, since the plurality of sensor portions 151 each have a shape that is long in the separation direction of the optical axes A1 and A2, that is, in the direction perpendicular to the alignment direction of the sensor portions 151, even if the condensed spot SP1 of the reflected light moves in accordance with a change in the distance to the object, the reflected light can be received by each sensor portion 151. Therefore, even if the distance to the object changes, the object can be more properly detected on the basis of the output from each sensor portion 151.

As shown in FIG. 5A, the projection optical system LS1 projects the laser light to the target region with a beam shape that is long in a direction corresponding to the alignment direction of the plurality of sensor portions 151. Accordingly, the object detection range can be expanded in the longitudinal direction of the beam. In addition, since the sensor portions 151 are aligned in a direction corresponding to the longitudinal direction of the beam, a division region corresponding to each sensor portion 151 can be smoothly set, and by increasing the number of sensor portions 151, the resolution of object detection in the longitudinal direction of the beam can be easily increased.

As shown in FIG. 12A to FIG. 12D and FIG. 13A to FIG. 13D, each sensor portion 151 has a shape in which the width of the portion (portion on the Y-axis negative side) away from the projection optical system LS1 is smaller than that of the portion (portion on the Y-axis positive side) close to the projection optical system LS1. Accordingly, when the condensed spot SP1 expands as the distance to the object becomes shorter, the condensed spot SP1 is less likely to be located on the adjacent sensor portions 151. Therefore, it is possible to suppress erroneous detection that the object exists in the division regions corresponding to the adjacent sensor portions 151.

As shown in FIG. 12A to FIG. 12D, each sensor portion 151 has a portion (linearly inclined portion) whose width decreases as the distance from the projection optical system LS1 increases. In addition, as shown in FIG. 13A to FIG. 13D and FIG. 15, each sensor portion 151 has a portion (a portion bent in an arc shape in FIG. 13A to FIG. 13D, a linearly inclined portion and a portion bent in an arc shape in FIG. 15) whose width decreases as the distance from the projection optical system LS1 increases. Accordingly, when the condensed spot SP1 expands while moving in the Y-axis negative direction as the distance to the object becomes shorter, it is possible to inhibit the condensed spot SP1 from being also located on the adjacent sensor portions 151 while ensuring an amount of the reflected light received by the normal sensor portion 151. Therefore, the measurement accuracy can be improved.

In the example of FIG. 13A to FIG. 13D and FIG. 15, each sensor portion 151 is set to have a T-shape. Accordingly, it is possible to more appropriately inhibit the condensed spot SP1 of the reflected light from being also located on the sensor portions 151 adjacent to the normal sensor portion 151 that should receive the reflected light.

In the example of FIG. 12A to FIG. 12D, each sensor portion 151 is set to have a trapezoidal shape. In this configuration, the condensed spot SP1 of the reflected light is more likely to be also located on the sensor portions 151 adjacent to the normal sensor portion 151 as compared with the case where each sensor portion 151 has a T-shape, but the amount of light received by the normal sensor portion 151 can be increased.

As shown in FIG. 10A to FIG. 10D, FIG. 12A to FIG. 12D, and FIG. 13A to FIG. 13D, the light-receiving optical system LS2 condenses the reflected light from the farthest distance (here, 20 m) in the distance measurement range, onto the vicinity of an end portion of the sensor portion 151 on the side (Y-axis positive side) close to the projection optical system LS1, and condenses the reflected light from the closest distance (here, 0.3 m) in the distance measurement range, onto the vicinity of an end portion of the sensor portion 151 on the side (Y-axis negative side) away from the projection optical system LS1. Accordingly, distance measurement can be performed even when the object exists at any distance position in the distance measurement range.

As shown in FIG. 5A, the light-receiving optical system LS2 includes the condensing lens 130 which condenses the reflected light onto the photodetector 150, and the opening 131 through which the optical axis A1 of the projection optical system LS1 passes is provided in the condensing lens 130. Accordingly, the optical axis A1 and the optical axis A2 can be made closer to each other, so that the optical unit 40 can be made compact while ensuring a wide effective diameter of the condensing lens 130. In addition, since the optical axis A1 and the optical axis A2 can be made closer to each other, the amount of movement of the condensed spot SP1 corresponding to a change in the distance to the object can be reduced. Therefore, the reflected light is easily received by the photodetector 150.

As shown in FIG. 6A, when the base member 20 rotates about the rotation axis R10, a range in the circumferential direction centered on the rotation axis R10 is scanned with the projection light emitted from each optical unit 40. At this time, since the projection directions of the projection lights from the respective optical units 40 are different from each other in the direction (Z-axis direction) parallel to the rotation axis R10 as shown in FIG. 6B, the ranges scanned with the respective projection lights are shifted from each other in the direction parallel to the rotation axis R10. Therefore, the entire range scanned with these projection lights is a wide range obtained by integrating the scanning ranges of the respective laser lights shifted from each other in the direction parallel to the rotation axis R10. Therefore, the scanning range in the direction parallel to the rotation axis R10 can be effectively expanded. Moreover, when the scanning range in the direction parallel to the rotation axis R10 is expanded as described above, an object can be detected in the wide scanning range parallel to the rotation axis R10.

As shown in FIG. 5A, the optical axis A1 of the projection optical system LS1 and the optical axis A2 of the light-receiving optical system LS2 are aligned in the circumferential direction of the rotation axis R10, and the optical axis A2 of the light-receiving optical system LS2 is located at a position on the rear side in the rotation direction of the rotary part 60 with respect to the optical axis A1 of the projection optical system LS1. Accordingly, in the duration from the time when the laser light is projected to the time when the laser light is received, the optical axis A2 of the light-receiving optical system LS2 comes closer to the position of the optical axis A1 of the projection optical system LS1 at the timing when the laser light is projected. Thus, the reflected light can be more favorably received by the light-receiving optical system LS2.

<Modification>

The configuration of the laser radar 1 can be modified in various ways other than the configuration shown in the above embodiment.

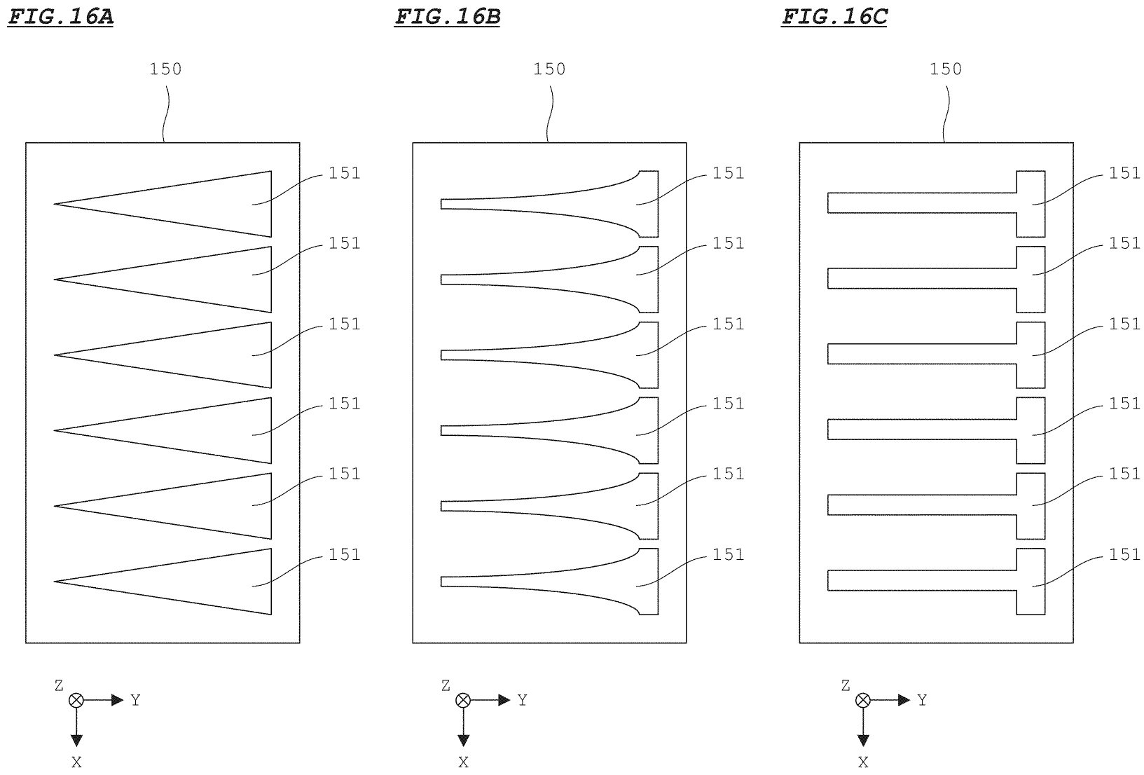

For example, in the above embodiment, several shapes are shown as the shapes of the sensor portions 151, but each sensor portion 151 may have another shape as long as each sensor portion 151 has a shape that is long in the separation direction of the optical axes A1 and A2. For example, each sensor portion 151 may have an isosceles triangle shape as shown in FIG. 16A, or each sensor portion 151 may be formed in a shape in which the upper and lower sides are recessed inward in a curved shape as shown in FIG. 16B. Alternatively, each sensor portion 151 may be formed in a T-shape in which the corners are bent in a rectangular shape as shown in FIG. 16C.

The amount of the reflected light received by the photodetector 150 decreases as the distance to the object increases. That is, the amount of the reflected light received by the photodetector 150 is inversely proportional to the square of the distance to the object. Therefore, it is preferable to set the shape of each sensor portion 151 in consideration of this point. That is, when the shape of each sensor portion 151 is set such that the width of the portion away from the projection optical system LS1 is smaller than that of the portion close to the projection optical system LS1, it is preferable to set the shape of each sensor portion 151 such that a sufficient amount of the reflected light received can be ensured in a range where the distance to the object is long.

In the configuration example of FIG. 5C, the photodetector 150 includes the six sensor portions 151, but the number of sensor portions 151 disposed in the photodetector 150 is not limited thereto. For example, two to five sensor portions 151 may be provided in the photodetector 150, or seven or more sensor portions 151 may be provided in the photodetector 150. As the number of sensor portions 151 disposed in the photodetector 150 is increased, the resolution of object detection in the longitudinal direction of the projection light can be increased.

In the above embodiment, each laser light source 110 is a surface-emitting laser light source having a light emission surface that is longer in one direction, but is not limited thereto, and may be an end face-emitting laser light source. In addition, projection light may be formed by integrating the laser lights emitted from the plurality of laser light sources 110.

In the above embodiment, a plurality of the optical units are arranged at equal intervals (60° intervals) along the circumferential direction about the rotation axis R10, but do not necessarily have to be installed at equal intervals.

In the above embodiment, the motor 13 is used as a drive part that rotates the rotary part 60, but instead of the motor 13, a coil and a magnet may be disposed in the fixing part 10 and the rotary part 60, respectively, to rotate the rotary part 60 with respect to the fixing part 10. In addition, a gear may be provided on the outer peripheral surface of the rotary part 60 over the entire circumference, and a gear installed on a drive shaft of a motor installed in the fixing part 10 may be meshed with this gear, whereby the rotary part 60 may be rotated with respect to the fixing part 10.

In the above embodiment, the projection directions of the projection lights projected from the respective optical units 40 are set to directions different from each other, by installing the mirrors 42 of the respective optical units 40 at inclination angles different from each other, but the method for making the projection directions of the projection lights projected from the respective optical units 40 different from each other is not limited thereto.

For example, the mirror 42 may be omitted from each of the six optical units 40, and six structures 41 may be radially installed such that the inclination angles thereof with respect to a plane perpendicular to the rotation axis R10 are different from each other. Alternatively, in the above embodiment, the mirror 42 may be omitted, and instead, the installation surface 21 may be subjected to mirror finish such that the reflectance of the installation surface 21 is increased. Still alternatively, in the above embodiment, each optical unit 40 includes one mirror 42, but may include two or more mirrors. In this case, the angle, with respect to the Z-axis direction, of the projection light reflected by a plurality of mirrors and projected to the target region may be adjusted on the basis of the angle of one of the plurality of mirrors.

It is also possible to apply the structure according to the present invention to a device that does not have a distance measurement function and has only a function to detect whether or not an object exists in the projection direction on the basis of a signal from the photodetector 150. In this case as well, the scanning range in the direction (Z-axis direction) parallel to the rotation axis R10 can be expanded.

The configuration of the optical system of each optical unit 40 is not limited to the configuration shown in the above embodiment. For example, the opening 131 may be omitted from the condensing lens 130, and the projection optical system LS1 and the light-receiving optical system LS2 may be separated from each other such that the optical axis A1 of the projection optical system LS1 does not extend through the condensing lens 130.

In the above embodiment, in order to expand the scanning range in the direction parallel to the rotation axis R10, the projection directions of the projection lights projected from the plurality of the optical units 40 are made different from each other in the direction (Z-axis direction) parallel to the rotation axis R10. However, the projection directions of the projection lights projected from the plurality of the optical units 40 may be set to be the same in the direction (Z-axis direction) parallel to the rotation axis R10.

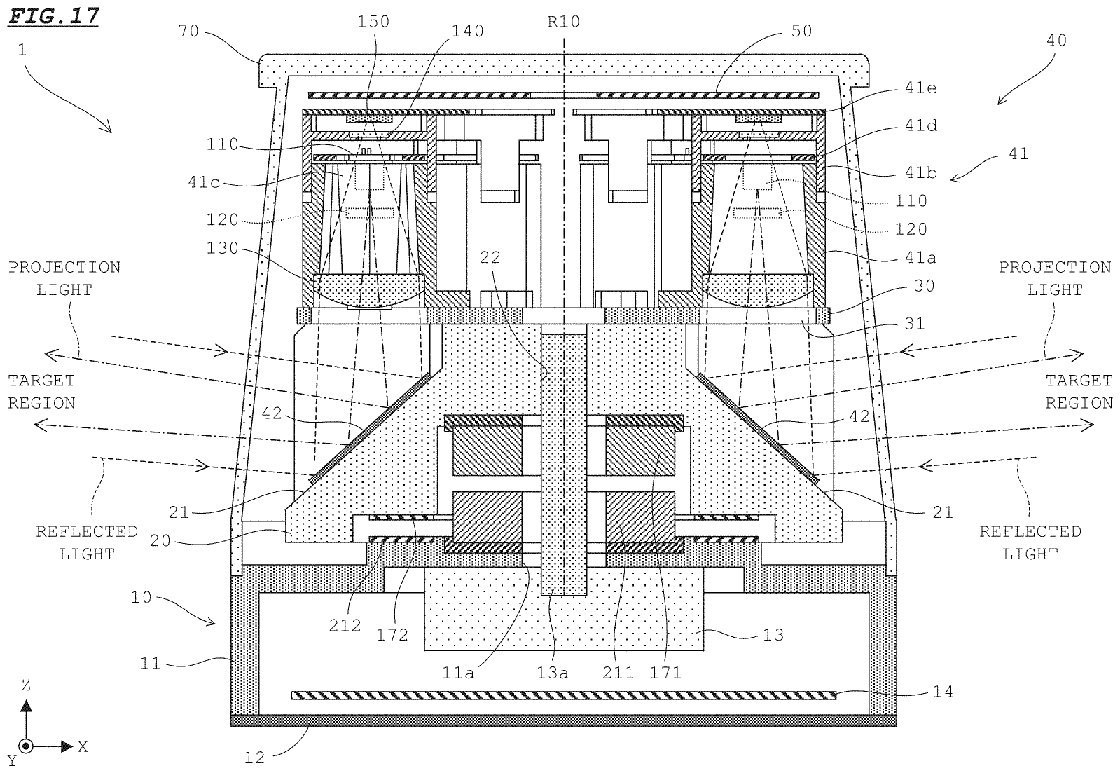

FIG. 17 is a cross-sectional view showing a configuration of the laser radar 1 according to this modification. In this modification, the inclination angle, with respect to a horizontal plane (X-Y plane), of the installation surface 21 on the X-axis positive side of the rotation axis R10 and the inclination angle, with respect to the horizontal plane, of the installation surface 21 on the X-axis negative side of the rotation axis R10 are equal to each other, so that the inclination angles of the two mirrors 42 installed on these installation surfaces 21 are also equal to each other. Similarly, the inclination angles of the other installation surfaces 21 are set to the same angle as those of the above two installation surfaces 21, so that the inclination angles of the other mirrors 42 are also set to the same angle as those of the above two mirrors 42. Accordingly, the projection directions of the projection lights projected from the six optical units 40 are the same in the direction parallel to the rotation axis R10.

When the projection directions of all the optical units 40 are set to be the same in the direction parallel to the rotation axis R10 as described above, the detection frequency for the range around the rotation axis R10 can be increased. Accordingly, a high frame rate can be achieved without increasing the rotation speed.

In the above embodiment, the plurality of the optical units 40 are installed in the laser radar 1, but the laser radar 1 may be configured to include merely one pair of the projection optical system LS1 and the light-receiving optical system LS2. In addition, the laser radar 1 does not necessarily have to be configured to rotate the pair of the projection optical system LS1 and the light-receiving optical system LS2 about the rotation axis, and may be configured to project projection light to a fixed target region, receive reflected light of the projection light, and perform object detection for the target region.

In addition to the above, various modifications can be made as appropriate to the embodiments of the present invention, without departing from the scope of the technological idea defined by the claims.

What is claimed is:

1. A laser radar comprising:
a projection optical system configured to project laser light emitted from a laser light source, to a target region; and
a light-receiving optical system configured to condense reflected light that is the laser light reflected by an object existing in the target region, onto a photodetector, wherein
the projection optical system and the light-receiving optical system are disposed such that optical axes thereof are separated from each other,
the photodetector includes a plurality of sensor portions aligned in a direction perpendicular to a separation direction of the optical axes, and
the plurality of sensor portions each have a shape that is long in the separation direction of the optical axes.

2. The laser radar according to claim 1, wherein the projection optical system projects the laser light to the target region with a beam shape that is long in a direction corresponding to an alignment direction of the plurality of sensor portions.

3. The laser radar according to claim 1, wherein the sensor portion has a shape in which a width of a portion away from the projection optical system is smaller than that of a portion close to the projection optical system.

4. The laser radar according to claim 3, wherein the sensor portion has a portion whose width decreases as a distance from the projection optical system increases.

5. The laser radar according to claim 3, wherein the sensor portion has a T-shape.

6. The laser radar according to claim 3, wherein the sensor portion has a trapezoidal shape.

7. The laser radar according to claim 1, wherein the light-receiving optical system condenses the reflected light from a farthest distance in a distance measurement range, onto a vicinity of an end portion of the sensor portion on a side close to the projection optical system, and condenses the reflected light from a closest distance in the distance measurement range, onto a vicinity of an end portion of the sensor portion on a side away from the projection optical system.

8. The laser radar according to claim 1, wherein
the light-receiving optical system includes a condensing lens configured to condense the reflected light onto the photodetector, and
an opening through which the optical axis of the projection optical system passes is provided in the condensing lens.

9. The laser radar according to claim 1, further comprising:
a base member;
a drive part configured to rotate the base member about a rotation axis; and
a plurality of optical units arranged on the base member at a predetermined interval in a circumferential direction about the rotation axis and each configured to project laser light in a direction away from the rotation axis, wherein
the plurality of optical units each include the projection optical system and the light-receiving optical system.

10. The laser radar according to claim 9, wherein projection directions of the laser lights from the plurality of optical units are different from each other in a direction parallel to the rotation axis.

11. The laser radar according to claim 9, wherein projection directions of the laser lights from the plurality of optical units are the same in a direction parallel to the rotation axis.

12. The laser radar according to claim 9, wherein
the optical axis of the projection optical system and the optical axis of the light-receiving optical system are aligned in the circumferential direction about the rotation axis, and
the optical axis of the light-receiving optical system is located at a position on a rear side in a rotation direction of the base member with respect to the optical axis of the projection optical system.
